(19) United States
(12) Patent Application Publication
(10) Pub. No.: US 2024/0282218 A1
(43) Pub. Date: Aug. 22, 2024

(54) A PORTABLE ASSISTIVE DEVICE FOR CHALLENGED INDIVIDUALS

(71) Applicants: Aishwarya KARNATAKI, Pimple Saudagar, Pune (IN); Parikshit SOHONI, Warje, Pune (IN)

(72) Inventors: Aishwarya KARNATAKI, Pimple Saudagar, Pune (IN); Parikshit SOHONI, Warje, Pune (IN)

(21) Appl. No.: 18/569,240

(22) PCT Filed: Jun. 11, 2022
(86) PCT No.: PCT/IN2022/050537

§ 371 Date: Dec. 12, 2023

(30) Foreign Application Priority Data
Jun. 13, 2021 (IN) 202121010635

(51) Int. Cl. G09B 21/00; G06F 3/01

(52) U.S. Cl. CPC G09B 21/009; G06F 3/014; G06F 3/016; G06F 3/017

(57) ABSTRACT

A portable assistive device converting sign language to text and speech includes a first wearable device 120, a second wearable device 125, a third wearable device 130 and a handheld device 115. The first wearable device 120 and second wearable device 125 receives gestures input through plurality of sensors 135 and 140. The first wearable device 120, the second wearable device 125, the third wearable device 130 and the handheld device 115 independently communicate with each other. The first wearable device 120 displays gestures on the display unit 315, the second wearable device 125 emits and captures audio through a speaker 340 and a microphone 345 respectively. The server 110 preferable hosted on cloud environment converts the gesture data into text or speech using machine learning and artificial intelligence algorithms.

### FIELD OF THE INVENTION

The present invention relates to an assistive communication device for differently abled people and more particularly to a wearable assistive device that converts sign language to text and speech, and vice versa.

### BACKGROUND OF THE INVENTION

Communication is an integral part of human life and hence considered as a life skill. Unfortunately, millions of deaf-mute people in the world rely on sign language to communicate. However, a vast majority of hearing people face difficulties in understanding the sign language. This presents a dreadful problem for deaf-mute population in their everyday life causing limited social interaction to high unemployment rates.

Sign language is an obvious tool used by differently abled people to communicate. The prior art has many devices that are linked to sign language in one or the other way. However, sign language is difficult to understand for normal human beings and require proper training to understand it. The prior art has different device that convert Hand gesture recognition to text and speech.

Currently, differently abled students learn the regional sign language in schools which may vary as per the region. The regional barrier presents a significant challenge to differently abled students to communicate with other differently abled students.

IN202041038106 to Jaswanth Kranthi Boppana et. al is a smart glove for recognizing and communicating sign language and associated method thereof. The patent application discloses a smart glove including plurality of sensors, processing unit, speaker and a power supply unit. The smart gloves are used for recognizing and for the communication of sign language. It discloses an audio output and an operating method for the smart gloves used for converting hand gestures.

U.S. Pat. No. 8,140,339B2 to George Washington University is a method and apparatus for translating hand gestures. The patent discloses a sign language recognition apparatus and a method of translating hand gestures into speech or written text. It includes sensors connected to the hand, arm and shoulder to measure the gestures, microprocessor, accelerometers. The sign language can be translated efficiently to speech or written text with the help of the multiple sensors which measure all the minute dynamic and static gestures.

Most of the prior art rely upon an embedded system connected to the gloves that helps in converting the hand gestures or sign language in to digital form. Some prior arts make use of single glove, some can convert gesture in to speech, some convert gesture into text, some use microprocessor, some use only microcontrollers and some systems have limited set of gestures fed in the memory compared to others. None of the prior art provides facility of two way communication among differently abled people and communication of differently abled people with normal people.

There is a need of a device that converts sign language gestures in to text and speech, and vice versa. Further there is a need for a device that eases communication for differently abled people.

### SUMMARY OF THE INVENTION:

A portable assistive device for challenged individuals a display unit for displaying data, a memory for storing data, a microphone for capturing sound, a speaker for emitting sound, a plurality of ports. A first wearable device connecting with a plurality of sensors through a plurality of strands. The first wearable device including: a microcontroller for processing data received from the plurality of sensors, a configuring the microcontroller to receive data from the plurality of sensors. A motor vibrator configured to alert the user vibrating the first wearable device.

A communication module connecting the first wearable device with a second wearable device. The second wearable device connecting with a plurality of sensors through a plurality of strands. The second wearable device including: a microcontroller for processing data received from the plurality of sensors, a multiplexer configuring the microcontroller 350 to receive data from the plurality of sensors. A third wearable device communicating with the first wearable device. the second wearable device and the hand held device through the communication module. The third wearable device including sensors capturing sensor data, a microcontroller processing said sensor data and a memory for storing sensor data.

The first wearable device, the second wearable device and the third wearable device wirelessly connecting with a handheld device. The handheld device including: a first module configured to receive gesture data on press of a switch, a second module configured to process gesture data using machine learning algorithm and artificial intelligence algorithm, a third module configured to stream real time background sounds and processing sounds to obtain equivalent gestures. A fourth module displaying gesture data and a fifth module for assessing user inputs on gesture data. A server communicating with the handheld device through internet. The server processing gesture data using machine learning and artificial intelligence algorithms.

The microcontroller starts recording gesture data on pressing the switch. The microcontroller stops recording gesture data on subsequent press of the switch. The ports receive strands for communicating with the plurality of sensors respectively. The first module receiving the gesture data including gesture name, method of performing gesture, word/phrase to train the machine learning algorithm. The gesture data is converted into relevant text or speech through machine learning and artificial intelligence algorithms on the server. The third module processing sound using machine learning algorithms and displaying gesture, image, GIFs on the display unit.

### BRIEF DESCRIPTION OF DRAWINGS

The objectives and advantages of the present invention will become apparent from the following description read in accordance with the accompanying drawings wherein

FIG. 1 illustrates working environment of a portable assistive device converting sign language to text and speech and vice versa in accordance with the present invention;

FIG. 2 shows the portable assistive device converting sign language to text and speech and vice versa of FIG. 1;

FIG. 3 illustrates schematic view of the portable assistive device converting sign language to text and speech and vice versa of FIG. 1; and

FIG. 4 illustrates homepage of the handheld device of FIG. 1.

### DETAILED DESCRIPTION OF THE INVENTION

The invention described herein is explained using specific exemplary details for better understanding. However, the invention disclosed can be worked on by a person skilled in the art without the use of these specific details.

References in the specification to “one embodiment” or “an embodiment” means that particular feature, structure, characteristic, or function described in connection with the embodiment is included in at least one embodiment of the invention. The appearances of the phrase “in one embodiment” in various places in the specification are not necessarily all referring to the same embodiment.

References in the specification to “preferred embodiment” means that a particular feature, structure, characteristic, or function described in detail thereby omitting known constructions and functions for clear description of the present invention.

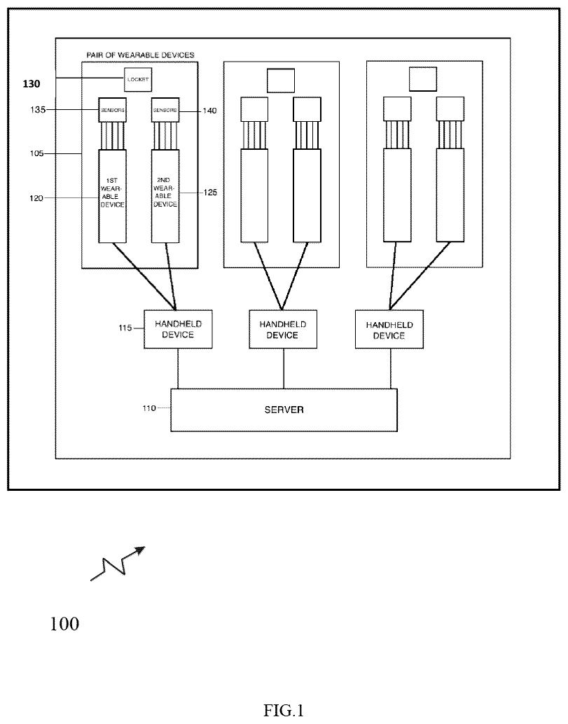

Referring to FIG. 1, a portable assistive device converting sign language to text and speech, and vice versa 100 hereinafter referred as a portable assistive device 100 in accordance with the present invention is described. The portable assistive device 100 includes a plurality of sets of wearable devices 105 that communicate with a server 110 through respective handheld devices 115. Accordingly, each set of wearable devices 105 include a first wearable device 120, a second wearable device 125 and a third wearable device 130. The first wearable device 120 and second wearable device 125 are connected to a plurality of sensors 135 and 140. The third wearable device 130 is connected wirelessly to either of said wearable devices 120, 125 along with the handheld devices 115.

The first wearable device 120 and the second wearable device 125 are approximately identical to each other such that each of them are wearable on a left band and a right hand of the individual like a wristwatch. However, the shape and size of the first and second wearable devices may vary in other embodiments of the present invention.

The handheld device 115 communicates with the first the second and the third wearable devices 120, 125, 130 respectively. In this one embodiment, the handheld device 115 is a cellphone. However, in other embodiments the handheld device 115 is replaceable by a tablet, laptop or a mobile phone configured according to the present invention. The first wearable device 120, the second wearable device 125 and the third wearable device 130 are wirelessly connected to the handheld device 115 preferably through connecting medium such as Bluetooth, NFC (Near Field Communication), Wi-Fi, Infrared, or the like.

The third wearable device 130 is worn by the user around the neck like an ornament or a necklace. The third wearable device 130 records the inclination angle, movement of the user's body for example, the user leaning forward, the user standing straight, the user leaning backwards or the like.

In accordance with the present invention, the first wearable device 120, and the second wearable device 125 record movements of respective hands of the individuals device 100, and after interpreting the movements, the second device 125 plays audio relevant to that movement. The first wearable device 120 simultaneously displays the text relevant to the movement for which the audio is being played for the second device 125.

In this preferred embodiment, the first wearable device 120 is worn on left band of the individual and the second wearable device 125 is worn on right hand of the individual. However, it is to be noted that the preference of wearing first and second wearable devices 120, 125, varies in as per user

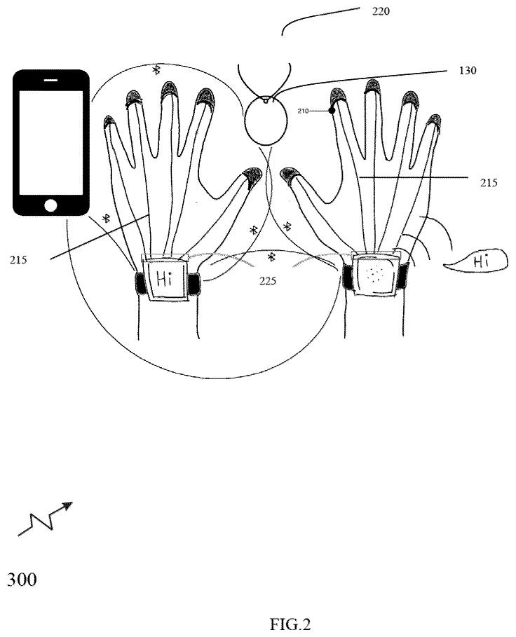

Referring to FIG. 2, the plurality of wearable sensors 135, 140 are connected to respective first wearable 120 and second wearable device 125 by a plurality of strands 205. The first wearable device 120 and the second wearable device 125 are worn on the wrist by the individuals preferably through straps, belts and the like. The device 100 also includes a switch 210. In accordance with the present invention, each of the wearable sensors 135, 140 are advantageously removably positioned on a tip of respective finger. In this preferred embodiment, the sensors 135, 140 are ring type sensors that are wearable like a finger ring.

The wearable sensors 135, 140 are, for example accelerometer, gyroscopic sensors and the like. It is, understood, however that a first end of a strand 205 is removably connected to respective wearable devices i.e. the first or the second wearable device 120, 125 and the second end of the strand 205 is connected to respective sensors 135, 140 positionable on the fingertip. The wearable devices 120, 125 include a plurality of ports 225 to receive the first end of the strand 205. In accordance with the present invention, the strand 205 is a semi-elastic wire like construction that transmits signals from the sensors to the respective wearable devices 120, 125.

In the present invention, the switch 210 is preferably positioned on the right-hand middle phalanx of the index finger. The switch 210 connects with the second wearable device 125 and the plurality of sensors 140 through wire strands. In other embodiments of the present invention, the switch 210 may be positioned on lefthand, righthand or both as per the requirement. In an alternate embodiment of the present invention, the type of switch 210 varies from press button, touch button, slider or the like. In accordance with the present invention, the third wearable device 130 is worn preferably through a link chain 220.

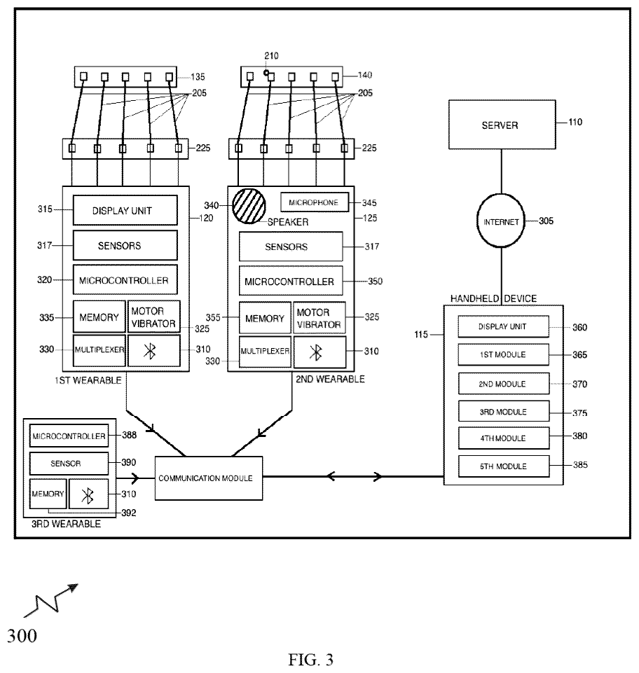

Referring to FIG. 3, a schematic of the portable assistive device 100 is described. The device 100 has the first wearable device 120, the second wearable device 125, the third wearable device 130, the handheld device 115 and the server 110. The first wearable device 120 is connected to five sensors through five respective strands 205. It is noted however that, each sensor is positioned on a respective finger of an individual during the operation of the device 100. The first wearable device 120 is also connected to the second wearable device 125 and a handheld device 115 by wireless communication. The handheld device 115 is futher connected to the server 110 by wireless connection preferably through internet 305.

The second wearable device 125 is connected to respective five sensors 140 through respective five strands 205. The second wearable device 125 is also connected with the handheld device 115 through a communication module 310 and with the first wearable device 120 through wireless communication. In other embodiments of the present invention, the first wearable device 120 is inter-connected with the second wearable device 125. The second wearable device 125 further connects with the handheld device 115. In yet another embodiment of the present invention, the first wearable device 120 and the second wearable device 125 are configure to directly communicate with the server 110 through wireless communication.

Accordingly, the first wearable device 120 includes the communication module 310, a display unit 315, plurality of sensors 317, a microcontroller 320, a vibrator 325, a multiplexer 330 and a first memory 335. The display unit 315 advantageously displays gestures/ animations, GIFs (Graphical Images) or the like. The display unit 315 receives data/signals from the microcontroller 320 in accordance with the present invention. The plurality of sensors 317, records the vibrations. acceleration of the motions performed by the individual wearing the first wearable device 120. The vibrator 325 includes vibrating motor that is an input means to the individual wearing the device 100. The vibrator 325 is selectively activable by the microcontroller 320. The strands 205 transfer gesture data from the sensors 135 towards first microcontroller 320.

The multiplexer 330 facilitates the microcontroller 320 to connect to multiple sensors 135, 140 and receive data. The communication module 310 enables communication between the first wearable device 120, the second wearable device 125, third wearable device 130 and the handheld device 115. The first memory 335 stores data received from the sensors 135, 140 and data generated by the first wearable device 120.

Accordingly, the second wearable device 125 includes a speaker 340, a microphone 345, a second microcontroller 350, a second memory 355 and the communication module 310. In another embodiment, the second wearable device 125 includes a screen also. The speaker 340 is configured in accordance with the present invention to emit the audio signals received from the handheld device 115. In context of the present invention, the device includes an amplifier (not shown) to amplify the audio output from the speaker 340. The microphone 345 records the surrounding sounds around the second wearable device 125 and communicates with the second microcontroller 350. In other embodiment of the same invention, there can be more than one microphone 345 connected to first hand held device 120 or second hand held device 125 or third hand held device 130.

The second memory 355 stores data received from the sensors 135, 140 and data generated by the second wearable device 125. The communication module 310 connects the second wearable device 125 with the handheld device 115 The communication module 310 communicates the second wearable device 125 with the handheld device 115. The strands 205 transfer gesture data from the sensors 140 towards second microcontroller 350. In accordance with the present invention, on press of the switch 210. the microcontroller 350 is configured to transmit a start signal to the handheld device 115 to initiate recording gestures. Similarly, on subsequent press of the switch 210, the microcontroller 350 receives stop signal and communicates with the handheld device 115 to stop recording the gestures.

The third wearable device 130 includes a microcontroller 388, a sensor 390, a third memory 392 and the communication module 310. The sensor 390 is preferably an accelerometer or a gyroscopic sensor in this particular embodiment however, the type of sensor varies in other embodiments of the present invention. The third memory 392 stores data received from the sensors 390. The communication module 310 connects the third wearable device 130 with the handheld device 115 and either of the wearable devices 120, 125. The microcontroller 388 processes the sensor data and communicates with the handheld device 115 or wearable devices 120, 125 respectively. In accordance with the present invention, the first wearable device 120 the second wearable device 125 and the third wearable device 130 are synchronized to record the gesture on press of the switch 210.

The handheld device 115 includes a display 360, a first module 365, a second module 370 and a third module 375. The display 360 has a User Interface that includes input means for e.g. press button to initialize appropriate mode to operate the device 100. In accordance with the present invention the User interface has a first learning mode, a second training mode and a third listening mode. The user selects the appropriate mode by pressing appropriate key.

The first module 365 i.e. a data collection module is configured to receive gesture data from the users of the device 100. The first module 365, receives request from the user to record the gesture data of a particular gesture. The gesture data includes respective gesture name, method of performing gesture, word/phrase and the like. The first module 365 records gesture data between the start and stop signals received by pressing the switch 210. The first module 365 stores the gesture data in the server 110. The stored gesture data trains a machine learning module to assess the gesture with equivalent text, speech or sound.

The second module 370 i.e. a gesture conversion module is configured for receiving gesture from the user. The second module 370, receives the gesture data from the first and second wearable device 120, 125 and 130 worn by the user of the device 100. The received gesture data is processed using the machine learning algorithm/artificial intelligence algorithms in the server 110 to obtain the equivalent text or speech of the received gesture.

Further, the server 110 communicates the processed text on the handheld device 115 such that the handheld device 115 displays text on the display unit 315 of the first wearable device 120. Similarly, the equivalent audio of the gesture is played through the speakers 340 of the second wearable device 125.

The third module 375 i.e. a listening module is configured to continuously receive the sound through the microphone 345 of the second wearable device 125. In other embodiments of the same invention the third module can be configured to receive the sound from multiple microphones placed on either 120,125 or 130. The third module 375, streams the sound received from the second wearable device 125 on the server 110 in real-time. The speech to text algorithm is deployed on the server 110 that converts the sound into equivalent text. Further, the converted text is received by the handheld device 115 through internet 305. Accordingly, the received text is converted into equivalent gestures on the handheld device 115.

The handheld device 115 streams the gestures on the first wearable device 120 such that the first wearable device 120 displays the animated gestures received from the handheld device 115. In accordance with the present invention, the third module 375 facilitates the user to record customized sounds along with the gesture data and store in the server 110. Accordingly, the third module 375 is configured to process customized sounds using machine learning algorithms and display the gesture, image, GIFs relevant to that sound. Further, the third module 375 is also configured to alert the user through the vibrating motor 325.

The fourth module 380 i.e. a learning module is configured for displaying information relevant to a predefined gesture to train the challenged individual. The fourth module 380 receives the gesture data from the server 110. Accordingly, the fourth module 380 displays the gesture data including list of words, phrases, sentences with their respective meaning along with the steps of performing the gestures. Accordingly, the information displayed on the handheld device 115 assists the challenged individuals to learn the gesture and the meaning of that particular gesture.

The fifth module 385 i.e. assessment module is configured to assist the challenge individuals in learning sign language. The fifth module 385 facilitates connection of multiple wearable devices with the single handheld device 115. For example, a trainer connects the wearable devices of the trainees through the fifth module 385 to teach a gesture. The trainer receives gesture from trainees. Further, the trainer sends the response through the fifth module 385 on assessing the performed gestures.

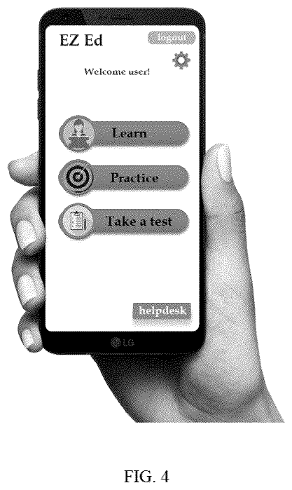

Referring to FIGS. 1-4 an operational flow of the portable assistive device for challenged individuals is described. In operation the user of the device 100 wears the first wearable device 120 and the second wearable device 125 on the respective hands. Further, the user wears the third wearable device 130 around the neck using the link chain. The user connects the first, the second and the third wearable devices 120, 125 and 130 through the communication module 310. In a next step, the user connects the first wearable devices 120, the second, 125 and the third wearable device 130 with the handheld device 115 through wireless communication. The user connects the handheld device 115 with the server 110 through the internet 305. Further, the user wears the wearable sensors 135, 140 on the fingertip of respective hands.

The strands 205 connects the wearable sensors 135, 140 with the respective wearable devices 120, 125 through the plurality of ports 225. The user presses the switch 210 to initiate recording gesture performed through the wearable sensors 135, 140. Simultaneously, the third wearable device 130 also, transmits the sensor data captured by the sensors 390 to the hand held device 115. The user again presses the switch 210 to stop recording gestures. The strands 205 transfer the gesture data from the wearable sensors 135, 140 to respective wearable devices 120, 125. The wearable devices 120, 125 transmit the gesture data wirelessly to the handheld device 115.

Further, the first module 365 stores the gestures data received from the wearable sensors 135, 140, 317, 318, 390 and the first, second and third wearable devices 120,125 and 130 in the server 110. Accordingly, the machine learning module converts the gesture data into text or speech through the machine learning algorithm/artificial intelligence algorithms on the server 110. The converted text and speech is received by the hand held device 115 of the performed gesture and is displayed on the display unit 360. Further, the audio file relevant to the gesture is streamed through the speakers 340 of the second wearable device 125.

In context of the present invention, the user activates the third module 375 to receive the sounds playing around the second wearable device 125 through the microphone 345. The received sounds are streamed to the server 110 through the third module 375. The speech to text algorithm deployed on the server 110 obtains equivalent text of the received sound. The text equivalent to the recorded sound is received by the handheld device 115 where the text is converted into gestures. Further, said gestures are streamed on the display unit of the first wearable device 120.

A preferred method of recording gesture data is described. In an initial step. the users of device 100 wear the first wearable device 120 and second wearable device 125 on respective hands. In a next step, the user wears the third wearable device 130 around the neck. In a next step, the first wearable device 120, the second wearable device 125 and the third wearable device 130 are inter-connected with one another and with the handheld device 115. In a next step, the details of the user recording the gestures along with the gesture data are received through the first module 365.

In a next step, the gesture data between the start and stop signals obtained by pressing the switch 210 are recorded. The recorded gesture data are authenticated by concerned authority and the gesture data are stored in the server 110. In a next step, the stored gesture data trains the machine learning module to convert gesture data to speech or text and background sounds to text or images or GIFs.

The device 100 advantageously, provides easy two way communication between the differently abled people and normal people. The device 100 advantageously, uses accelerometers at the tip of fingers of the gloves that enable the user to capture the orientation of the tip of the fingers. The device 100 advantageously, has sensors on each figure and a huge set of gestures that improve the communication quality for differently abled people.

The foregoing description of specific embodiments of the present invention has been presented for purposes of illustration and description. They are not intended to be exhaustive or to limit the present invention to the precise forms disclosed, and obviously many modifications and variations are possible in light of the above teaching.

The embodiments were chosen and described in order to best explain the principles of the present invention and its practical application, to thereby enable others, skilled in the art to best utilize the present invention and various embodiments with various modifications as are suited to the particular use contemplated.

It is understood that various omission and substitutions of equivalents are contemplated as circumstance may suggest or render expedient, but such are intended to cover the application or implementation without departing from the scope of the present invention.

1. A portable assistive device for challenged individuals 100 a display unit 315 for displaying data, a memory 335 for storing data, a microphone 345 for capturing sound, a speaker 340 for emitting sound, a plurality of ports 225, characterized in that said device 100 comprising:
A first wearable device 120 connecting with a plurality of sensors 135 through a plurality of strands 205; the first wearable device 120 including: a microcontroller 320 for processing data received from the plurality of sensors 135, a multiplexer 330 configuring the microcontroller 320 to receive data from the plurality of sensors 135; a motor vibrator 325 configured to alert the user vibrating the first wearable device 120;
a communication module 310 connecting the first wearable device 120 with a second wearable device 125; the second wearable device 125 connecting with a plurality of sensors 140 through a plurality of strands 205; the second wearable device 125 including: a microcontroller 350 for processing data received from the plurality of sensors 140, a multiplexer 330 configuring the microcontroller 350 to receive data from the plurality of sensors 140;
a third wearable device 130 communicating with the first wearable device 120, the second wearable device 125 and the hand held device 115 through the communication module 310, the third wearable device 130 including sensors 390 capturing sensor data, a microcontroller 388 processing said sensor data and a memory for storing sensor data;
the first wearable device 120, the second wearable device 125 and the third wearable device 130 wirelessly connecting with a handheld device 115; the handheld device 115 including: a first module 360 configured to receive gesture data on press of a switch 210, a second module 370 configured to process gesture data using machine learning algorithm and artificial intelligence algorithm, a third module 375 configured to stream real time background sounds and processing sounds to obtain equivalent gestures, a fourth module 380 displaying gesture data and a fifth module 385 for assessing user inputs on gesture data; and
a server 110 communicating with the handheld device 115 through internet 305; the server 110 processing gesture data using machine learning and artificial intelligence algorithms.

2. A portable assistive device for challenged individuals 100 as claimed in claim 1, wherein the microcontroller 350 starts recording gesture data on pressing the switch 210.

3. A portable assistive device for challenged individuals 100 as claimed in claim 1, wherein the microcontroller 350 stops recording gesture data on subsequent press of the switch 210.

4. A portable assistive device for challenged individuals 100 as claimed in claim 1, wherein the ports 225 receive strands 205 for communicating with the plurality of sensors 135, 140 respectively.

5. A portable assistive device for challenged individuals 100 as claimed in claim 1, wherein the first module 365 receiving the gesture data including gesture name, method of performing gesture, word/phrase to train the machine learning algorithm.

6. A portable assistive device for challenged individuals 100 as claimed in claim 1, wherein the gesture data is converted into relevant text or speech through machine learning and artificial intelligence algorithms on the server 110.

7. A portable assistive device for challenged individuals 100 as claimed in claim 1, wherein the third module 375 processing sound using machine learning algorithms and displaying gesture, image, GIFs on the display unit 315.
